(19) United States
(12) Patent Application Publication
(10) Pub. No.: US 2012/0047163 A1
(43) Pub. Date: Feb. 23, 2012

(54) AUTOMATED CREATION OF A PRINT-READY GROUP DIRECTORY

(75) Inventors: Michael E. Farrell, Webster, NY (US); Michael C. Marinaccio, Webster, NY (US)

(73) Assignee: XEROX CORPORATION, Norwalk, CT (US)

(21) Appl. No.: 12/860,969

(22) Filed: Aug. 23, 2010

(51) Int. Cl. G06F 17/30

(52) U.S. Cl. 707/769; 707/E17.014

(57) ABSTRACT

Method and systems of automatically creating a print-ready representation of a group directory are disclosed. A processing device receives a selection of a plurality of individuals having information residing in a database and a selection of a format for a group directory. The device determines one or more information fields associated with the selected format and transmits a request for information stored in the one or more determined fields and associated with the plurality of individuals to the database. The processing device receives the requested information, generates a template for each individual including at least a portion of the received information associated with the individual, and generates a print-ready representation of the group directory organized in the selected format and including the template for each individual.

### BACKGROUND

Social networking Internet websites and Internet-based collaboration tools have become more prevalent. Users of social networking websites often form groups to connect with friends, family members and other individuals having a common interest, occupation and/or the like. A user can form a group including other users of the website with whom the user wishes to share information regarding one or more topics. Alternately, the user can join or be added to an existing group pertaining to a topic of interest.

Likewise, collaboration tools are used to group business people working on a common project or in a particular technology area to share ideas, work product and the like. A manager or another user can add members to a group associated with a particular task in order to encourage communication between the members.

Member lists are used to identify the individuals that make up a particular group so that, for example, off-line communication can be facilitated. In addition, member lists can foster bonding, allegiance and general connectedness within the group.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a method of automatically creating a print-ready representation of a group directory may include receiving, by a processing device, a selection of a plurality of individuals, wherein information pertaining to each individual resides in a database, receiving, by the processing device, a selection of a format for the group directory, determining, by the processing device, one or more information fields associated with the selected format, transmitting, by the processing device, a request for information associated with the plurality of individuals to the database and comprising information stored in the one or more determined information fields, receiving, by the processing device, the requested information for the plurality of individuals, for each individual, generating, by the processing device, a template comprising at least a portion of the received information associated with the individual, and generating, by the processing device, a print-ready representation of the group directory. The print-ready representation comprises the template for each individual in the plurality of individuals and is organized in the selected format.

In an embodiment, a system for automatically creating a print-ready representation of a group directory may include a processing device, a database storage device, configured to be accessed by the processing device, that contains a database, and a computer readable storage medium in operable communication with the processing device. The computer-readable storage medium contains one or more programming instructions that, when executed, cause the processing device to receive a selection of a plurality of individuals, wherein information pertaining to each individual resides in the database, receive a selection of a format for the group directory, determine one or more information fields associated with the selected format, transmit a request for information associated with the plurality of individuals that comprises information stored in the one or more determined information fields, receive the requested information for the plurality of individuals, generate, for each individual, a template comprising at least a portion of the received information associated with the individual, and generate a print-ready representation of the group directory, where the print-ready representation comprises the template for each individual in the plurality of individuals and is organized in the selected format.

In an embodiment, a method of automatically creating a print-ready representation of a group directory may include receiving, by a processing device, an update to information stored in at least one information field of a first database record associated with a first individual, identifying, by the processing device, a group with which the first individual is associated, identifying, by the processing device, one or more second individuals associated with the group, where each of a plurality of second database records is associated with a corresponding second individual, identifying, by the processing device, a format for the group directory associated with the group, determining, by the processing device, one or more information fields associated with the determined format, transmitting, by the processing device, a request for information associated with the first individual and each second individual to the database, where the requested information comprises information stored in the one or more determined information fields in the corresponding first and second database records, receiving, by the processing device, the requested information for each of the first individual and the one or more second individuals, and generating, by the processing device, a print-ready representation of the group directory. The print-ready representation comprises a template for each of the first individual and the one or more second individuals and is organized in the identified format. The template comprises at least a portion of the received information associated with the corresponding individual.

### BRIEF DESCRIPTION OF THE DRAWINGS

FIG. 1 depicts a flow diagram for an exemplary method of automatically creating a print-ready representation of a group directory according to an embodiment.

FIG. 2 depicts a flow diagram for an alternate exemplary method of automatically creating a print-ready representation of a group directory according to an embodiment.

FIG. 3 depicts a block diagram of exemplary internal hardware that may be used to contain or implement program instructions according to an embodiment.

### DETAILED DESCRIPTION

The following terms shall have, for the purposes of this application, the respective meanings set forth below.

A “database” refers to an organized collection of digital data. A database may include a plurality of “records,” where each record includes data corresponding to a particular subject, such as an individual. An individual data element in a particular record may be stored in one of a plurality of “information fields.” Each information field may include information of a particular type, such as a first name, a last name, an address or any other type of information.

“Geographic information” refers to information pertaining to a location. For example, geographic information may include information pertaining to a continent, a country, a state, a region, a city or metropolitan area, a neighborhood, a street, a particular address and/or the like.

A “group directory” refers to a listing of information pertaining to a plurality of individuals. The individuals having information listed in a group directory may have one or more common characteristics associated with them. For example, each individual may be a part of a social networking group, an employee of an organization, participating on a common project or the like.

“Printable information” refers to information intended to be included for printing or display in a print-ready representation. “Non-printable information” refers to information that is not intended to be included for printing or display in a print-ready representation. Each individual data element associated with an individual may be either printable or non-printable information depending upon a particular print-ready representation. For example, occupation data may be printable information in a first print-ready representation for a first group directory and non-printable information in a second print-ready representation for a second group directory.

A “printing device” refers to a device capable of performing one or more print-related functions. For example, a printing device may include a printer, a fax machine, a multifunction device or other similar equipment. A “multifunction device” is a device that is capable of performing two or more distinct print-related functions. For example, a multifunction device may have print and scan capabilities.

A “print-ready representation” refers to a document, computer-readable file, and/or the like that are capable of producing an output document. For example and without limitation, each of a PDF file, a PostScript file, and a PCL file is an exemplary computer-readable print-ready representation capable of producing an output document when printed or displayed.

A “social network” for an individual refers to one or more other individuals having a specific interdependency or relationship with the individual. A “social networking environment” refers to a computer-based system used to establish and maintain social networks for individuals. A social networking environment may be accessed using a computer via a website or other electronic means.

A “template” refers to a construct used to organize information pertaining to an individual. For example and without limitation, a template may include one or more fields for which information is requested and an arrangement for the fields. As such, information may be displayed using a template in a consistent manner. In some instances, if certain information has a particular value, a different template may be selected to display all of the information associated with the certain information. As used herein, a template may further include rules-based and/or conditional layout instructions for page layout such that the format for the template is non-static and modifiable based on the information provided.

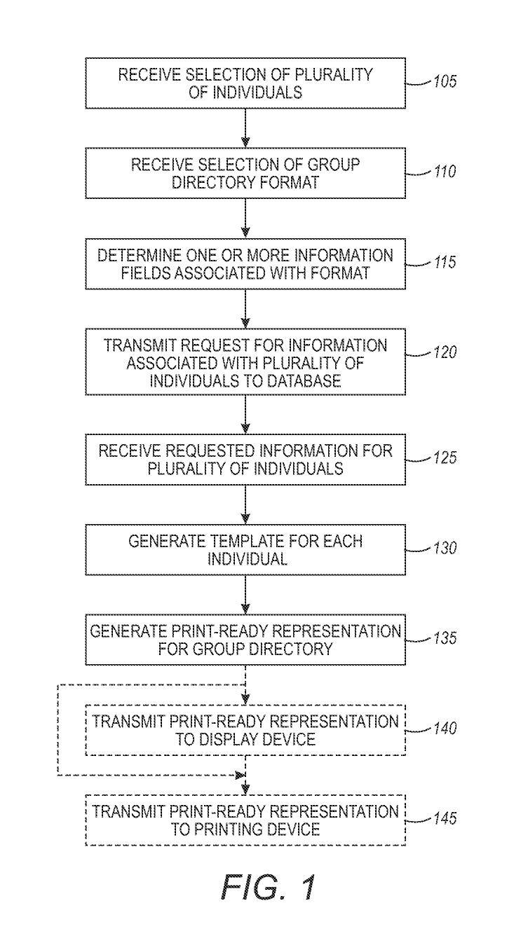

FIG. 1 depicts a flow diagram for an exemplary method of automatically creating a print-ready representation of a group directory according to an embodiment. As shown in FIG. 1, a selection of a plurality of individuals may be received 105. For example, a processing device may receive 105 a selection of a plurality of individuals. In an embodiment, the selection of the plurality of individuals may be received 105 from a user that desires to prepare a group directory. In an alternate embodiment, the selection of the plurality of individuals may be received 105 as part of an update process. For example, once a day, week, month year or other period of time or intermittently, a new directory may automatically be generated as part of an update process. In such a case, a query may be used to identify the individuals to select. The resulting individuals may then be provided to and received 105 by the processing device. The query may also be performed by the processing device, in which case the selected individuals may be received 105 by the processing device as a result of the query.

Information pertaining to each of the plurality of individuals may reside in a database. In an embodiment, the database may include a record for the individual containing information pertaining to the individual. Exemplary types of information in an individual's database record may include, without limitation, first name, middle name, last name, address, state, city, building location, floor, office number, time zone, occupation, position, project team(s), photograph/headshot, and/or the like. The information in the database for a group of individuals may be “well-formed” (i.e., each individual's record in the group may include the same types of information for all or substantially all individuals in the group). For example, a First Name field for each individual's database record may include the first name of the corresponding individual.

In an embodiment, the plurality of individuals may include members of a user group in a social networking environment. In an alternate embodiment, the plurality of individuals may include employees of an organization, such as a business, a team, an orchestra, a non-profit organization, a club, and/or the like. Alternate and/or additional groupings of individuals may also be selected within the scope of this disclosure.

A selection of a format for the group directory may also be received 110. For example, the processing device may receive 110 a selection of a format for the group directory. In an embodiment, the format may include tabular text. In an alternate embodiment, the format may include, for each individual in the group, a head shot and textual information corresponding to the individual. In another embodiment, a format may include project-specific or affiliation-specific background images.

In yet another embodiment, a format may position individuals within the group directory based on information corresponding to the individual. For example, a format may arrange individuals in a group directory based on time zone to assist someone who examines the group directory in determining an appropriate time to contact each individual.

Alternately, a format may arrange individuals in a group directory based on geographic location. In such an embodiment, the format may have a background image of a map associated with the locations of the individuals.

In an alternate embodiment, the format may arrange individuals by a role or position within an organization. For example, if the group directory is for a symphony organization, individuals who are musicians may be displayed in an orchestral arrangement. Alternately, if the format is for a sports team, individuals who are players may be displayed based on a depth chart and/or at positions on a field background image while individuals who are coaches or other staff members may be displayed on the sidelines. Additional and/or alternate formats are included within the scope of this disclosure.

One or more information fields associated with the selected format may be determined 115. For example, the processing device may determine 115 one or more information fields associated with the selected format. The one or more determined information fields correspond to information used to populate a group directory having the selected format. The information fields required to populate a particular format for a group directory may be stored in association with the format. For example, each format may be stored in a database record containing, among other things, a format name and a list of the information fields utilized by the format. Alternate and/or additional methods of determining the information fields for each format may be performed within the scope of this disclosure. The requested information may include printable information and non-printable information. For example, for a particular format, printable information may include first name, last name, address and position for each individual, and non-printable information may include a current or default time zone for each individual. The non-printable information may be used to select a template containing the printable information for each individual according to the current format. In an embodiment, the printable information may include a head shot, photo, avatar or other image associated with the individual.

A request for information associated with the plurality of individuals may be transmitted 120 to the database. In an embodiment, the processing device may transmit 120 the request for information. The requested information includes information stored in the one or more determined information fields in the database record associated with each individual. In an embodiment, a single request may be used to request information for each of the plurality of individuals.

The requested information for each individual may be received 125 from the database. In an embodiment, the processing device may receive 125 the requested information for each individual. In an embodiment, a single response containing the requested information for the plurality of individuals may be received 125. The requested information may then be separated based upon the individual to whom the information pertains.

A template may be generated 130 for each individual. In an embodiment, the processing device may generate 130 the template for each individual. Each template may include at least a portion of the requested information associated with the individual. For example, a template for a particular individual may include the printable textual information and/or photographic information associated with the individual received in the requested information.

In an embodiment, the template for the printable requested information and/or photographic information for an individual may cause the information to appear similar to a business card, a Rolodex® card, and/or any other combination of images and/or text. The manner in which the template for each individual is organized may be determined based on the format for the group directory. In an embodiment, templates for particular individuals may differ based on the information associated with each individual. For example, if the organization for which the group directory is being formed is a sports team, the template for a player and a coach may differ. Similarly, an orchestral member and the conductor may have differing templates for an orchestral group directory.

A print-ready representation of the group directory may be generated 135. In an embodiment, the processing device may generate 135 the print-ready representation of the group directory. The print-ready representation may include the template for each individual in the plurality of individuals. In an alternate embodiment, the print-ready representation may include the template for a subset of the plurality of individuals. The print-ready representation may be organized in the selected format. In particular, the print-ready representation may have the templates for each individual organized in the selected format.

In an embodiment, the print-ready representation may be generated 135 in a Portable Document Format (PDF) or Postscript (PS) file format. Other file formats may also be used within the scope of this disclosure.

The processing device may cause the location of the templates within the print-ready representation for the one or more individuals to be organized based upon at least a portion of the requested information. In an embodiment, if the requested information for each individual includes a time zone in which the individual is located (either current or default), the print-ready representation may be generated 135 by arranging the templates for the plurality of individuals based on the time zone associated with each individual.

In an alternate embodiment, if the requested information for each individual includes a geographic location for the individual, the print-ready representation may include a background map and may be generated 135 by arranging the templates for the plurality of individuals on the background map based on the geographic location associated with each individual. In such an embodiment, the background map may be selected based on the geographic locations associated with the plurality of individuals. In a variation of such an embodiment, multiple background maps may be selected based on the geographic locations associated with the plurality of individuals. For example, if some of the individuals to be included in the group directory are in North America and other individuals are in Europe, separate background maps showing relevant portions of North America and Europe may be selected for the group directory.

In another embodiment, if the requested information for each individual includes an occupation for the individual, the print-ready representation may be generated 135 by arranging the templates for the plurality of individuals based on the occupation for each individual. For example, the occupation for each individual may include a sports team position or a musical instrument played by the individual (or other role) in an orchestra or band.

In an embodiment, the print-ready representation may include a background image selected based on one or more of the selected format, at least one of the determined information fields and at least a portion of the requested information. For example, the selected format for a group directory may be geographically based as described above with respect to the background maps. Alternately, the inclusion of a time zone as a determined information field may be used to select a background image for the group directory. Furthermore, a portion of the requested information, such as “player” and/or “coach” for an occupation or position, may be used to select a field as a background image. Additional and/or alternate information may be used to determine a background image within the scope of this disclosure.

In an embodiment, the print-ready representation may be transmitted 140 to a display device so that it may be displayed. For example, the processing device may transmit 140 the print-ready representation to the display device. The display device may display the print-ready representation to a user for review. In an embodiment, the user may select a new format for the group directory after reviewing the print-ready representation on the display device. Upon the reception of a new selection for the format, a determination may be made as to whether a request for additional information for the plurality of individuals in the group directory should be transmitted 120 to the database. Alternately, new templates may be generated 130 for each individual based on the new format. Additional and/or alternate operations may be performed based on the receipt of new information from the user.

In an embodiment, the print-ready representation may be transmitted 145 to a printing device for printing. For example, the processing device may transmit 145 the print-ready representation to the printing device. In such an embodiment, the print-ready representation may be printed for presentation to one or more group members, supervisors or other users in a hard copy form. In an embodiment, the print-ready representation may be transmitted 140 to the display device prior to being transmitted 145 to the printing device at the request of a user.

In an embodiment, the print-ready representation may be sized or re-sized based on the capabilities of the printing device to which it is destined. For example, if the printing device is capable of printing on poster-sized paper, the print-ready representation may be sized to utilize such paper size. In an embodiment, information regarding the capabilities of a particular printing device may be stored as part of a print driver file accessible by the processing device. In an alternate embodiment, the processing device may request such information from the printing device.

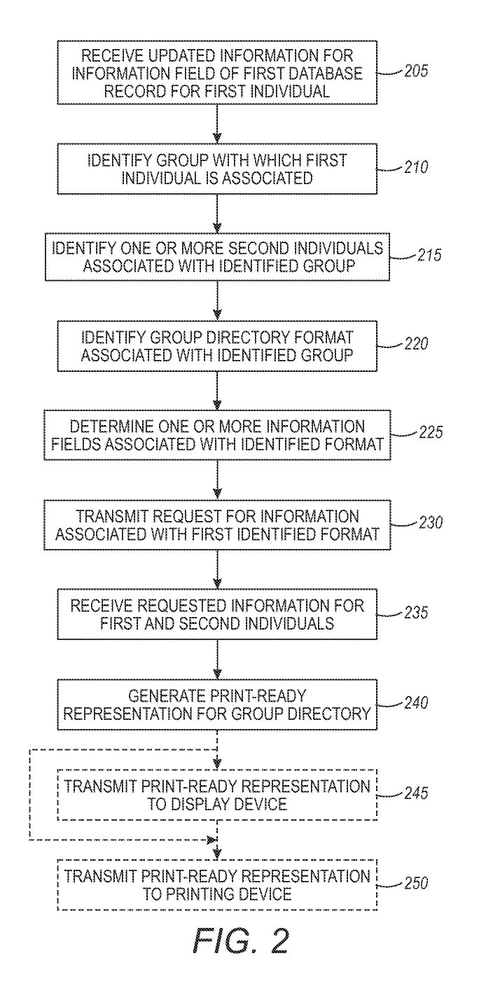

FIG. 2 depicts a flow diagram for an alternate exemplary method of automatically creating a print-ready representation of a group directory according to an embodiment. As shown in FIG. 2, an update to information stored in at least one information field of a first database record associated with a first individual may be received 205. In an embodiment, the update to the information associated with the first individual may be received 205 by a processing device.

Information pertaining to each of a plurality of individuals may reside in a database. In an embodiment, the database may include a record for an individual which contains information pertaining to the individual. Exemplary types of information in an individual's database record may include, without limitation, first name, middle name, last name, address, state, city, building location, floor, office number, time zone, occupation, position, project team(s), photograph/headshot, and/or the like.

The information update may result from a database entry to the record associated with the first individual. For example, the individual may be a new employee of an organization, may join a group, may undergo a name change or change in address, and/or the like. The information update may occur automatically, such as an age change when the individual's birthday passes, or as a result of user data entry. Alternate and/or additional types of updates may be performed, reasons for updates may be undertaken and mechanisms for updating may be utilized within the scope of this disclosure.

A group with which the first individual is associated may be identified 210. In an embodiment, the processing device may identify 210 the group with which the first individual is associated. In such an embodiment, an automatic updating process may be initiated when updated information is provided for any individual in the identified group. Alternately, an update flag may be toggled when updated information is provided for an individual in the group, and a periodic or intermittent updating program may examine the flag to determine whether an update has occurred since a previously performed update. If the flag is set, the updating program may proceed to update the group directory. Alternate and/or additional processes for determining whether a group directory should be automatically updated may be performed within the scope of this disclosure.

One or more second individuals associated with the group may be identified 215. In an embodiment, the processing device may identify 215 the one or more second individuals associated with the group of which the first individual is associated. Each of a plurality of second database records may be associated with a corresponding second individual.

The information in the database for a group of individuals may be “well-formed” (i.e., each individual's record in the group may include the same types of information for all or substantially all individuals in the group). For example, a First Name field for each individual's database record may include the first name of the corresponding individual.

In an embodiment, the first individual and the plurality of second individuals may include members of a user group in a social networking environment. In an alternate embodiment, the first individual and the plurality of second individuals may include employees of an organization, such as a business, a team, an orchestra, a non-profit organization, a club, and/or the like. Alternate and/or additional groups of individuals may also be identified within the scope of this disclosure.

A format for the group directory associated with the group may also be identified 220. For example, the processing device may identify 220 a format for the group directory. In an embodiment, the format may include tabular text. In an alternate embodiment, the format may include, for each individual in the group, a head shot and textual information corresponding to the individual. In another embodiment, a format may include project-specific or affiliation-specific background images.

In yet another embodiment, a format may position individuals within the group directory based on information corresponding to the individual. For example, a format may arrange individuals in a group directory based on a current or default time zone associated with each individual to assist someone who examines the group directory in determining an appropriate time to contact each individual.

Alternately, a format may arrange individuals in a group directory based on geographic location. In such an embodiment, the format may have a background image of a map associated with the locations of the individuals.

In an alternate embodiment, the format may arrange individuals by a role or position within an organization. For example, if the group directory is for a symphony organization, individuals who are musicians may be displayed in an orchestral arrangement. Alternately, if the format is for a sports team, individuals who are players may be displayed based on a depth chart and/or at positions on a field background image while individuals who are coaches or other staff members may be displayed on the sidelines. Additional and/or alternate formats are included within the scope of this disclosure.

The identified format may be stored as part of a database record pertaining to the group. As such, an automatic update routine may determine the format for the group based on information stored in the group database record.

One or more information fields associated with the identified format may be determined 225. For example, the processing device may determine 225 one or more information fields associated with the identified format. The one or more determined information fields correspond to information used to populate a group directory having the identified format. The information fields required to populate a particular format for a group directory may be stored in association with the format. For example, each format may be stored in a database record containing, among other things, a format name and a list of the information fields utilized by the format. Alternate and/or additional methods of determining the information fields for each format may be performed within the scope of this disclosure. The requested information may include printable information and non-printable information. For example, for a particular format, printable information may include first name, last name, address and position for each individual, and non-printable information may include a current or default time zone for each individual. The non-printable information may be used to place a template containing the printable information for each individual according to the current format. In an embodiment, the printable information may include a head shot, photo, avatar or other image associated with the individual.

A request for information associated with the first individual and each second individual may be transmitted 230 to the database. In an embodiment, the processing device may transmit 230 the request for information. The requested information includes information stored in the one or more determined information fields in the corresponding first and second database records associated with each of the first individuals and the one or more second individuals. In an embodiment, a single request may be used to request information for the first individual and each of the second individuals.

The requested information for the first individual and each of the second individuals may be received 235 from the database. In an embodiment, the processing device may receive 235 the requested information. In an embodiment, a single response containing the requested information for the first individual and each of the second individuals may be received 235. The requested information may then be separated based upon the individual to whom the information pertains.

A print-ready representation of the group directory may be generated 240. In an embodiment, the processing device may generate 240 the print-ready representation of the group directory. The print-ready representation may include a template for each of the first individual and the one or more second individuals. The print-ready representation may be organized in the identified format. In particular, the print-ready representation may have the templates for each individual organized in the identified format.

Each template may include at least a portion of the requested information associated with the corresponding individual. For example, a template for a particular individual may include the printable textual information and/or photographic information associated with the individual received in the requested information.

In an embodiment, the template for the printable requested information and/or photographic information for an individual may cause the information to appear similar to a business card, a Rolodex® card, and/or any other combination of images and/or text. The manner in which the template for each individual is organized may be determined based on the format for the group directory. In an embodiment, templates for particular individuals may differ based on the information associated with each individual. For example, if the organization for which the group directory is being formed is a sports team, the template for a player and a coach may differ. Similarly, an orchestral member and the conductor may have differing templates for an orchestral group directory.

In an embodiment, the print-ready representation may be generated 240 in a Portable Document Format (PDF) or Postscript (PS) file format. Other file formats may also be used within the scope of this disclosure.

The processing device may cause the location of the templates within the print-ready representation for the one or more individuals to be organized based upon at least a portion of the requested information. In an embodiment, if the requested information for each individual includes a time zone in which the individual is located (either current or default), the print-ready representation may be generated 240 by arranging the templates for the plurality of individuals based on the time zone associated with each individual.

In an alternate embodiment, if the requested information for each individual includes a geographic location for the individual, the print-ready representation may include a background map and may be generated 240 by arranging the templates for the plurality of individuals on the background map based on the geographic location associated with each individual. In such an embodiment, the background map may be selected based on the geographic locations associated with the plurality of individuals. In a variation of such an embodiment, multiple background maps may be selected based on the geographic locations associated with the plurality of individuals. For example, if some of the individuals to be included in the group directory are in North America and other individuals are in Europe, separate background maps showing relevant portions of North America and Europe may be selected for the group directory.

In another embodiment, if the requested information for each individual includes an occupation for the individual, the print-ready representation may be generated 240 by arranging the templates for the plurality of individuals based on the occupation for each individual. For example, the occupation for each individual may include a sports team position or a musical instrument played by the individual (or other role) in an orchestra or band.

In an embodiment, the print-ready representation may include a background image selected based on one or more of the identified format, at least one of the determined information fields and at least a portion of the requested information. For example, the identified format for a group directory may be geographically based as described above with respect to the background maps. Alternately, the inclusion of a time zone as a determined information field may be used to select a background image for the group directory. Furthermore, a portion of the requested information, such as “player” and/or “coach” for an occupation or position, may be used to select a field as a background image. Additional and/or alternate information may be used to determine a background image within the scope of this disclosure.

In an embodiment, the print-ready representation may be transmitted 245 to a display device so that it may be displayed. For example, the processing device may transmit 245 the print-ready representation to the display device. The display device may display the print-ready representation to a user for review. In an embodiment, the user may select a new format for the group directory after reviewing the print-ready representation on the display device. Upon the reception of a new selection for the format, a determination may be made as to whether a request for additional information associated with the first individual and each second individual should be transmitted 230 to the database. Additional and/or alternate operations may be performed based on the receipt of new information from the user.

In an embodiment, the print-ready representation may be transmitted 250 to a printing device for printing. For example, the processing device may transmit 250 the print-ready representation to the printing device. In such an embodiment, the print-ready representation may be printed for presentation to one or more group members, supervisors or other users in a hard copy form. In an embodiment, the print-ready representation may be transmitted 245 to the display device prior to being transmitted 250 to the printing device at the request of a user. In an embodiment, the print-ready representation may be transmitted 250 to the printing device for printing automatically.

In an embodiment, the print-ready representation may be sized or re-sized based on the capabilities of the printing device to which it is destined. For example, if the printing device is capable of printing on poster-sized paper, the print-ready representation may be sized to utilize such paper size. In an embodiment, information regarding the capabilities of a particular printing device may be stored as part of a print driver file accessible by the processing device. In an alternate embodiment, the processing device may request such information from the printing device. In an embodiment, a printing device may be assigned to the group so that a proper format is automatically applied when an update to the first individual's information is received 205.

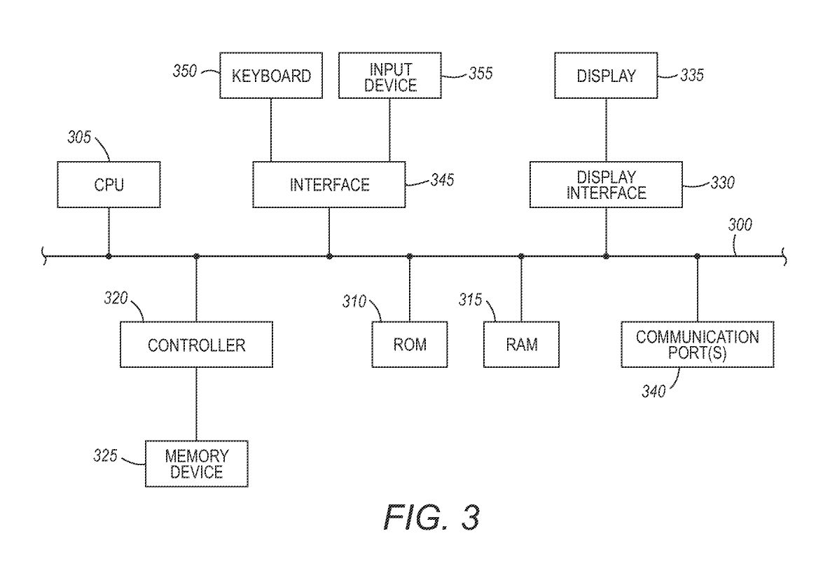

FIG. 3 depicts a block diagram of exemplary internal hardware that may be used to contain or implement program instructions, such as the process steps discussed above in reference to FIGS. 1 and 2, according to an embodiment. A bus 300 serves as the main information highway interconnecting the other illustrated components of the hardware. CPU 305 is the central processing unit of the system, performing calculations and logic operations required to execute a program. CPU 305, alone or in conjunction with one or more of the other elements disclosed in FIG. 3, is an exemplary processing device, computing device or processor as such terms are used within this disclosure. Read only memory (ROM) 310 and random access memory (RAM) 315 constitute exemplary memory devices.

A controller 320 interfaces with one or more optional memory devices 325 to the system bus 300. These memory devices 325 may include, for example, an external or internal DVD drive, a CD ROM drive, a hard drive, flash memory, a USB drive or the like. As indicated previously, these various drives and controllers are optional devices. Additionally, the memory devices 325 may be configured to include individual files for storing any feedback information, common files for storing groups of feedback information, or one or more databases for storing the feedback information.

Program instructions, software or interactive modules for providing the interface and performing any querying or analysis associated with one or more data sets may be stored in the ROM 310 and/or the RAM 315. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 330 may permit information from the bus 300 to be displayed on the display 335 in audio, visual, graphic or alphanumeric format. Communication with external devices, such as an optional printing device, may occur using various communication ports 340. An exemplary communication port 340 may be attached to a communications network, such as the Internet or an intranet.

The hardware may also include an interface 345 which allows for receipt of data from input devices such as a keyboard 350 or other input device 355 such as a mouse, a joystick, a touch screen, a remote control, a pointing device, a video input device and/or an audio input device.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method of automatically creating a print-ready representation of a group directory, the method comprising:
receiving, by a processing device, a selection of a plurality of individuals, wherein information pertaining to each individual resides in a database;
receiving, by the processing device, a selection of a format for the group directory;
determining, by the processing device, one or more information fields associated with the selected format;
transmitting, by the processing device, a request for information associated with the plurality of individuals to the database, wherein the requested information comprises information stored in the one or more determined information fields;
receiving, by the processing device, the requested information for the plurality of individuals;
for each individual, generating, by the processing device, a template comprising at least a portion of the received information associated with the individual; and
generating, by the processing device, a print-ready representation of the group directory, wherein the print-ready representation comprises the template for each individual in the plurality of individuals, wherein the print-ready representation is organized in the selected format.

2. The method of claim 1 wherein the plurality of individuals comprises a user group in a social networking environment.

3. The method of claim 1 wherein the plurality of individuals comprises a plurality of employees of an organization.

4. The method of claim 1 wherein the requested information for each individual comprises a time zone in which the individual is located, wherein generating the print-ready representation comprises arranging the templates for the plurality of individuals based on the time zone associated with each individual.

5. The method of claim 1 wherein the requested information for each individual comprises a geographic location for the individual, wherein the print-ready representation comprises a background map, wherein generating the print-ready representation comprises arranging the templates for the plurality of individuals on the map based on the geographic location associated with each individual.

6. The method of claim 1 wherein the requested information for each individual comprises an occupation for the individual, wherein generating the print-ready representation comprises arranging the templates for the plurality of individuals based on the occupation for each individual.

7. The method of claim 6 wherein the occupation for the individual comprises one or more of the following:
a sports team position; and
a musical instrument played by the individual.

8. The method of claim 1 wherein the print-ready representation comprises a background image selected based on one or more of the following:
the selected format;
at least one of the determined information fields; and
at least a portion of the requested information.

9. The method of claim 1 wherein the requested information for an individual comprises photographic information and textual information.

10. The method of claim 1, further comprising:
transmitting, by the processing device, the print-ready representation to a printing device for printing.

11. The method of claim 1, further comprising:
transmitting, by the processing device, the print-ready representation to a display device for displaying.

12. A system for automatically creating a print-ready representation of a group directory, the system comprising:
a processing device;
a database storage device configured to be accessed by the processing device, wherein the database storage device contains a database; and
a computer readable storage medium in operable communication with the processing device,
wherein the computer-readable storage medium contains one or more programming instructions that, when executed, cause the processing device to:
receive a selection of a plurality of individuals, wherein information pertaining to each individual resides in the database;
receive a selection of a format for the group directory;
determine one or more information fields associated with the selected format;
transmit a request for information associated with the plurality of individuals, wherein the requested information comprises information stored in the one or more determined information fields;
receive the requested information for the plurality of individuals;
generate, for each individual, a template comprising at least a portion of the received information associated with the individual; and
generate a print-ready representation of the group directory, wherein the print-ready representation comprises the template for each individual in the plurality of individuals, wherein the print-ready representation is organized in the selected format.

13. The system of claim 12, further comprising a printing device in operable communication with the processing device, wherein the computer-readable storage medium further contains one or more programming instructions that, when executed, causes the processing device to transmit the print-ready representation to the printing device.

14. The system of claim 12, further comprising a display device in operable communication with the processing device, wherein the computer-readable storage medium further contains one or more programming instructions that, when executed, causes the processing device to transmit the print-ready representation to the display device.

15. A method of automatically creating a print-ready representation of a group directory, the method comprising:
receiving, by a processing device, an update to information stored in at least one information field of a first database record associated with a first individual;
identifying, by the processing device, a group with which the first individual is associated;
identifying, by the processing device, one or more second individuals associated with the group, wherein each of a plurality of second database records is associated with a corresponding second individual;
identifying, by the processing device, a format for the group directory associated with the group;
determining, by the processing device, one or more information fields associated with the determined format;
transmitting, by the processing device, a request for information associated with the first individual and each second individual to the database, wherein the requested information comprises information stored in the one or more determined information fields in the corresponding first and second database records;
receiving, by the processing device, the requested information for each of the first individual and the one or more second individuals; and
generating, by the processing device, a print-ready representation of the group directory, wherein the print-ready representation comprises a template for each of the first individual and the one or more second individuals, wherein the template comprises at least a portion of the received information associated with the corresponding individual, wherein the print-ready representation is organized in the identified format.

16. The method of claim 15 wherein the group comprises a group in a social networking environment.

17. The method of claim 15 wherein the group comprises a plurality of employees of an organization.

18. The method of claim 15 wherein the requested information for each of the first individual and the one or more second individuals comprises photographic information and textual information.

19. The method of claim 15, further comprising:
transmitting, by the processing device, the print-ready representation to a printing device for printing.

20. The method of claim 15, further comprising:
transmitting, by the processing device, the print-ready representation to a display device for displaying.
